(19) United States
(12) Patent Application Publication
(10) Pub. No.: US 2003/0119460 A1
(43) Pub. Date: Jun. 26, 2003

(54) Transmitted power level indicator

(76) Inventor: Eliav Zipper, Tel Aviv (IL)

Correspondence Address: Eitan, Pearl, Latzer & Cohen Zedek, LLP, 10 Rockefeller Plaza, Suite 1001, New York, NY, 10020, US

(21) Appl. No.: 10/025,959

(22) Filed: Dec. 26, 2001

(51) Int. Cl. H04B 17/00

(52) U.S. Cl. 455/115; 455/117; 455/67.1; 455/566

(57) ABSTRACT

Briefly, in accordance with one embodiment of the invention, a transmitted power indictor that may indicate of a transmitted power level of a cellular-phone transceiver is provided.

### BACKGROUND

Cellular-phone transceivers, which may be mobile stations such as, for example hand held devices, mobile devices and the like may include a received signal strength indicator (RSSI) to display an indication of the received signal strength (RSS), an indicator of the battery power level or the like. However, an operator of the cellular-phone transceiver may need some other indication that may help to control power consumption of the cellular-phone transceiver.

Thus, current cellular-phone transceivers may need an indicator to display parameters to control power consumption of the cellular-phone transceiver.

### BRIEF DESCRIPTION OF TIE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read wit the accompanying drawings in which:

FIG. 1 is a block diagram of an portable communication device in accordance with an embodiment the present invention; and

FIG. 2 is a flow chat of a method of indicating a transmitted power level that may be used in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

It should be understood that the present invention may used in variety of applications. Although the present invention is not limited in this respect, the circuits and techniques disclosed herein may be used in many apparatuses such as transceivers of a radio system. Transceivers intended to be included within the scope of the present invention include, by a way of example only, portable communication devices that may include cellular radiotelephone transmitters and receivers, and the like.

Types of cellular radiotelephone transceivers intended to be within the scope of the present invention include, although are not limited to, Code Division Multiple Access (CDMA), CDMA 2000 and wide band CDMA (WCDMA) cellular radiotelephone transceivers for transmitting spread spectrum signals, Global System for Mobile communication (GSM) cellular radiotelephone transceivers, Time Division Multiple Access (TDMA) transmitters, Extended-TDMA (B-TDMA) transceivers for transmitting and receiving amplitude modulated (AM) and phase modulated signals, portable digital communication (.PDC) phone, dual mode or multi modes transceivers and the like.

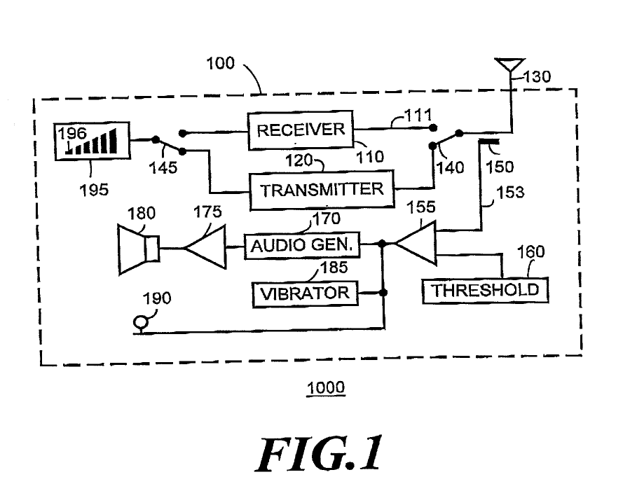

Turning to FIG. 1, a portable communication device 1000 in accordance with all embodiment of the present invention is shown. Although it should be understood that the scope and application of the present invention is in no way limited to this example, the portable communication device 1000 may comprise a cellular-phone transceiver 100. Portable communication device may be, for example, a hand held device, a vehicular phone, mobile station, a personal communication assistant (PCA) or the like.

Cellular-phone transceiver 100 may include a receiver 110, a transmitter 120, an antenna 130, a switch 140, a switch 145, a power level decoder 150, a comparator 155, a threshold 160, an audio generator 170, an audio amplifier 175, a loudspeaker 180, a vibrator 185, a light indicator 190, and a level indicator 195, although it should be understood to one skilled in the art that the scope of the present invention is in no way limited to the components of the cellular-phone transceiver 100 that were described above.

In operation antenna 130 may be used to transmit and to receive radio frequency (RF) signals of a cellular-phone communication system.

Antenna 130 may be, for example, a single antenna or a dual antenna. An example of a single antenna may be a dipole antenna, if desired.

Although the scope of the present invention is not limited in this respect, a received signal 111 may be received by receiver 110. Switch 140 may connect between antenna 130 to receiver 110 and switch 145 may connect between receiver 110 to level indicator 195.

Although the scope of the present invention is not limited in this respect level indicator 195 may be for example a graphical meter display such as, for example a bars display. Software may control the bars displayed on level indicator 195. A bar 196 may indicate one unit of strength of received signal 111. For example, displaying all bars on level indicator 195 lay be an indication of maximum received strength. No bars on level indicator 195 may be an indication that receiver 110 may not be receiving signals. Furthermore, the number of displayed bars may be an indication of the relative received signal strength. However, it should be understood that the present invention is in no way limited by this example and other types of level indicators may be included with alternative embodiments of the present invention.

Although the scope of the present invention is not limited in this respect, switches 140, 145 may connect transmitter 120 to antenna 130 and to level indicator 195. Switches 140, 145 may be digital semiconductor components, such as transistors, duplexers, diode, multiplexers combiners and the like or mechanical switches such as, for example, relays and the like.

Although the scope of the present invention is not limited in this respect, level indicator 195 may display a transmitted power level 153. Bars of level indicator 195 may display an approximated transmitted power level. A display of all the bars may indicate a maximum transmitted power level. No bars displayed may indicate no transmission.

In addition to, or apart from, displaying the transmitted power level by level indicator 195, power level decoder 150 may decode the power level of a transmitted signal 121. In alternative embodiments of the present invention, the decoding of the power level may be done by software, for example, the software may decode the power level according to calibration parameters that may be stored at the memory of cellular-phone transceiver 100. A decoded power level 153 may be provided to comparator 155. Comparator 155 may compare decoded power level 153 to threshold 160. Threshold 160 may be set to be below or equal to a predetermined dangerous level of radiation. For example, the threshold 160 may be set to 10 milliWatts.

Although the scope of the present invention is not limited in this respect, comparator 155 may provide a signal to audio generator 170 and/or to vibrator 185 and/or to light indicator 190 when a transmitted power level is above a threshold. Light indicator 190 may provide a light hazard to the operator of cellular-phone transceiver 100 that transmitted power level 153 is above threshold 160. Light source 160 may be for example, a lamp or a light emitted diode and the like.

In addition or apart from, the alerts describe above, vibrator 185 may provide vibrations to alert the operator of the cellular-phone transceiver 100 that transmitted power level 153 is above threshold 160.

Although the scope of the present invention is not limited in this respect, vibrator 153 may be the vibrator that is used to alert the operator of cellular-phone transceiver 100 of incoming calls. In addition to, or apart frog the alerts described above, audio generator 170 may generate an audible sound. Although the scope of the present invention is not limited in this respect, the audible sound may be a high pitch tone, a melody, a series of bursts or the like. The audible sound may be used to inform the operator of cellular-phone transceiver 100 that transmitted power level 153 is above threshold 160. The audible sound may be amplified by amplifier 175 and may be sounded by loudspeaker 180.

Although the scope of the present invention is not limited in this respect, audio generator 170 that may be used with this embodiment of the present invention may be the audio generator that may be used to generate rings of the cellular-phone transceiver 175. Furthermore, in alternative embodiments of the present invention, audio generator 170 may be provided by a digital signal processor (DSP) and software to generate an audible sound.

Although the scope of the present invention is not limited in this respect, in alternative embodiments of the present invention, audio generator 170 and/or vibrator 185 and or light indicator 190 may provide a continuous indication of the transmitted power level. For example, vibrator 170 may generate vibrations with different frequencies for different levels of transmitted power. Light indicator 190 may display different colors of light for different levels of transmitted power. For example, a green light may be displayed for a low power level and a red light may be displayed for a high power level. Furthermore, the audio generator 170 may provide different tones or melody for different levels of transmitted power level.

Although the scope of the present invention is not limited in this respect, it should be understood to one skilled in the art that other power level indicators may be used with embodiments of the present invention. Furthermore, audio generator 170 and vibrator 185 may be different from the audio generator and the vibrator that are used to generate indications for incoming calls.

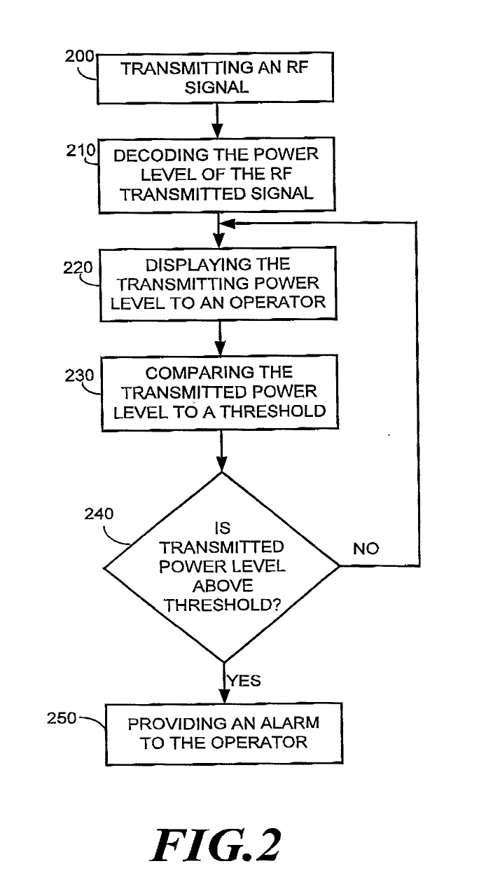

Turning to FIG. 2. a method of indicating a transmitted power level of cellular-phone transceiver 100 is shown. Although the scope of the present invention is not limited in this respect, an operator of a cellular-phone transceiver 100 may initiate a telephone call to a subscriber of cellular communication system. In response, transmitter 120 of cellular-phone transceiver 100 may transmit an RF signal (block 200) Decoder 150 may decode the power level of the transmitted RF signal (block 210). The decoded power level may be sent to level indicator 195 to be displayed to the operator (block 220). In addition to, or apart of, displaying the power level, comparator 155 may compare the transmitted power level to threshold 160 (block 230) For a transmitted power level below threshold, the operation of blocks 220, 230, 240 may be repeated. If the transmitted power level is above threshold 160 (block 240), an alarm may be provided to the operator (block 250).

Although the scope of the present invention is not limited in this respect, the alarm may be, for example, light, sound, vibrations and the like. Alternatively, an animated picture may be displayed, or the temperature of cellular-phone transceiver 100 may be increased or decreased. Furthermore, the type of alarm and the behavior of the alarm may be selected by the operator of cellular-phone transceiver 100. For example, if an audible alarm was selected the operator may select the tone and/or the melody of the audible alarm.

While certain features of the invention have been illustrated and described herein, many modifications, substitutions, changes, and equivalents will now occur to those skilled in the art. For example, the use of an adaptive function for varying a phase and amplitude of an output signal may be used in many devices other then transmitters. It is, therefore, to be understood that the appended claims are intended to cover all such modifications and changes as fall within the true spirit of the invention.

What is claimed is:

1. A portable communication device comprising:
a level indictor to provide an indication of a transmitted power level of a cellular-phone transmitter in the portable communication device.

2. The portable communication device of claim 1, further comprising a comparator to provide a signal to the level indicator if the transmitted power level is above a threshold.

3. The portable communication device of claim 2, wherein the indication comprises an audible sound.

4. The portable communication device of claim 2, wherein the indication comprises a light.

5. Tile portable communication device of claim 1, wherein the indication comprises a graphical meter display.

6. The portable communication device of claim 2, further comprising a vibrator to indicate the transmitted power level.

7. A portable communication device comprising:
a level indictor to provide an indication of a transmitted power level of a Global System for Mobile communication (GSM) cellular-phone transceiver when the transceiver is in a transmitting mode and to provide an indication of a received signal strength of the cellular-phone transceiver when the transceiver is in a receiving mode.

8. The portable communication device of claim 7, further comprising:
a comparator to determine whether the transmitted power level is equal to or above a threshold and to provide a signal to the level indicator.

9. The portable communication device of claim 8, wherein the indication comprises an audible sound.

10. The portable communication device of claim 8, wherein the indication comprises a light.

11. The portable communication device of claim 7, wherein the indication comprises a graphical meter display.

12. The portable communication device of claim 7, further comprising a vibrator to indicate the transmitted power level.
